(19) United States
(12) Patent Application Publication
(10) Pub. No.: US 2024/0132406 A1
(43) Pub. Date: Apr. 25, 2024

(54) Gypsum Panel Containing Reclaimed Gypsum

(71) Applicant: Gold Bond Building Products, LLC, Charlotte, NC (US)

(72) Inventors: Veda Evans, Charlotte, NC (US); Michael Blades, Indian Land, SC (US); R. G. Iyer, Charlotte, NC (US); Eli Stav, Charlotte, NC (US); Bradley J. Busche, Shelby, NC (US); Craig Robertson, Charlotte, NC (US); Gene Whittington, Fort Mill, SC (US); Joseph J. Bailey, Charlotte, NC (US)

(21) Appl. No.: 18/490,869

(22) Filed: Oct. 19, 2023

Related U.S. Application Data
(60) Provisional application No. 63/418,068, filed on Oct. 21, 2022.

(51) Int. Cl. C04B 28/14; B32B 5/02; B32B 7/02; B32B 13/02; B32B 13/08; B32B 13/14; C04B 18/167

(52) U.S. Cl. CPC C04B 28/14; B32B 5/02; B32B 7/02; B32B 13/02; B32B 13/08; B32B 13/14; C04B 18/167; C04B 2111/0062

(57) ABSTRACT

The present invention is directed to a gypsum panel and a method of making such gypsum panel. For instance, in one embodiment, the gypsum panel comprises a gypsum core and a first facing material and a second facing material sandwiching the gypsum core, wherein the gypsum core includes gypsum and one or more components of a reclaim gypsum panel, such as reclaimed gypsum and reclaimed facing material. The methods of the present invention are directed to making the aforementioned gypsum panels by providing the first facing material, providing a gypsum slurry comprising gypsum, water, and one or more components of a reclaim gypsum panel, such as reclaimed gypsum and reclaimed facing material, onto the first facing material, and providing a second facing material on the gypsum slurry.

### BACKGROUND OF THE INVENTION

In modern times, corporate sustainability initiatives and national environmental initiatives have become increasingly prominent and influential. Notably, the waste management of manufacturing processes has become a growing concern as manufacturers adjust their processes to better respond to environmental concerns of the manufacturer itself, the public, and administrative or governmental entities. As such, gypsum panel manufacturers have engaged in various corporate sustainability initiatives including the incorporation of reclaim gypsum panel components (i.e., waste gypsum panel components) in gypsum panels.

Generally, reclaim gypsum panels are gypsum panels that possess one or more properties or characteristics that may be undesirable. In the past, gypsum panel manufacturers have had difficulty incorporating components of reclaim gypsum panels in newly formed gypsum panels while also maintaining the desired characteristics and properties of the newly formed gypsum panels, particularly as the amount of reclaim gypsum panel components increases in the gypsum panel along with associated impurities. Indeed, the incorporation of components of reclaim gypsum panels in gypsum panels has traditionally resulted in gypsum panels having undesirable characteristics and properties.

As a result, there is a need for an improved gypsum panel that incorporates one or more components of reclaim gypsum panels in its composition while also having enhanced characteristics and properties.

### SUMMARY OF THE INVENTION

In accordance with one embodiment of the present invention, a gypsum panel is disclosed. The gypsum panel comprises a gypsum core and a first facing material and a second facing material sandwiching the gypsum core, wherein the gypsum core is formed from a gypsum slurry, the gypsum slurry comprising stucco, water, and a reclaim composition, wherein the gypsum slurry comprises stucco in an amount from about 60 wt. % to about 95 wt. %, and wherein the reclaim composition comprises reclaimed facing material and reclaimed gypsum, wherein the reclaimed facing material is present in the reclaim composition in an amount of about 15 wt. % or less, wherein the reclaimed facing material is present in the gypsum slurry in an amount of about 10 wt. % or less.

In accordance with another embodiment of the present invention, a method of making a gypsum panel is disclosed. The method comprises: providing a first facing material; depositing a gypsum slurry comprising stucco, water, and a reclaim composition, wherein the gypsum slurry comprises stucco in an amount from about 60 wt. % to about 95 wt. %, wherein the reclaim composition comprises reclaimed facing material and reclaimed gypsum, wherein the reclaimed facing material is present in the reclaim composition in an amount of about 15 wt. % or less, wherein the reclaimed facing material is present in the gypsum slurry in an amount of about 10 wt. % or less; providing a second facing material on the gypsum core, and allowing the stucco to convert to calcium sulfate dihydrate.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a cementitious panel, particularly a gypsum panel, and a method of making such a cementitious panel. In particular, the gypsum panel can include a gypsum core including components of a reclaim gypsum panel as defined herein. In this respect, the gypsum core can include gypsum (i.e., calcium sulfate dihydrate), any of the components of a reclaim gypsum panel (e.g., reclaimed gypsum and reclaimed facing material), and may include other optional additives. The present inventors have discovered that the gypsum panel disclosed herein can have various benefits due to the use of one or more components from a reclaim gypsum panel. For instance, the present inventors have discovered that the gypsum panel disclosed herein may reduce gypsum panel waste, decrease water usage in the formation of gypsum panels, reduce new material usage (e.g., stucco), improve sound reduction or damping performance, and/or lower energy usage in the formation of gypsum panels while also having other improved mechanical properties and characteristics. Notably, in one aspect, the gypsum panel disclosed herein may have an enhanced STC rating or NRC coefficient.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In general, the gypsum core may comprise gypsum. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

The gypsum core of the present disclosure may be formed from a gypsum slurry. The gypsum slurry may comprise a reclaim composition. The reclaim composition may comprise any component of a reclaim gypsum panel. For instance, in one aspect, the reclaim composition may comprise reclaimed gypsum, reclaimed facing material, or a combination thereof. In one aspect, the reclaim composition may comprise components of a reclaim gypsum panel that are calcined or uncalcined. For instance, the reclaim composition may comprise reclaimed gypsum and/or reclaimed facing material that is uncalcined.

The one or more components of a reclaim gypsum panel present in the reclaim composition may be derived from fire-resistant gypsum panels, water-resistant gypsum panels, and/or more generally any type of reclaim gypsum panel.

In some aspects, the reclaimed facing material may include material from a paper facing material, a fibrous (e.g., glass fiber) mat facing material, a polymeric facing material, and/or a combination thereof.

The reclaim composition of the present disclosure may be particularly beneficial when included in the gypsum slurry. In one aspect, the reclaim composition may reduce the setting time of the gypsum slurry, decrease energy usage in the formation of the gypsum panel, reduce new material usage (e.g., stucco, water), improve sound reduction or damping performance, and/or decrease gypsum panel waste.

The reclaim composition of the present disclosure may comprise water. For instance, water may be added to the reclaim composition. In this respect, the reclaim composition may be referred to as a reclaim slurry composition. The reclaim composition, including any components thereof, may comprise water in an amount less than about 60 wt. %, such as about 50 wt. % or less, such as about 40 wt. % or less, such as about 30 wt. % or less, such as about 20 wt. % or less, such as about 15 wt. % or less, such as about 12 wt. % or less, such as about 10 wt. % or less, such as about 8 wt. % or less, such as about 5 wt. % or less, such as about 2 wt. % or less. The reclaim composition, including any components thereof, may comprise water in an amount greater than about 0.1 wt. %, such as about 0.5 wt. % or more, such as about 1 wt. % or more, such as about 2 wt. % or more, such as about 5 wt. % or more, such as about 8 wt. % or more, such as about 10 wt. % or more, such as about 15 wt. % or more, such as about 20 wt. % or more, such as about 30 wt. % or more, such as about 40 wt. % or more.

Alternatively, water may not be added to the reclaim composition. In this respect, the reclaim composition may be referred to as a dry reclaim composition. However, it should be understood that the dry reclaim composition may include one or more components of a reclaim gypsum panel that comprise water, such as reclaimed gypsum.

In one aspect, the reclaim composition may decrease the amount of water used in forming the gypsum panel. Generally, water is combined with stucco to form the gypsum slurry. However, as previously disclosed, the gypsum slurry may include a reclaim composition. The inclusion of the reclaim composition may decrease the amount of water required to form a gypsum panel made in accordance with the present disclosure. For instance, the inclusion of the reclaim composition may decrease the amount of stucco required to form the gypsum panel, particularly the amount of stucco required to form the gypsum core. In this respect, less water may be utilized to react with the decreased amount of stucco.

Utilizing less water may be beneficial in the formation of a gypsum panel. For instance, the utilization of less water may allow for a gypsum panel with increased strength and/or nail pull resistance. Notably, when a gypsum panel is heated or dried, the heating or drying of the gypsum panel may result in the formation of air pockets or voids where water remains after the setting of the gypsum slurry (i.e., free water). Such air pockets or voids may decrease the strength of a gypsum panel. In a gypsum panel formed in accordance with the present disclosure, the amount of water to be evaporated from the gypsum panel may be less than a traditional gypsum panel. In this respect, a gypsum panel made in accordance with the present disclosure may have a decreased number or volume of air pockets or voids, and/or a different void size distribution than a traditional gypsum panel.

Generally, the weight ratio of the water to the stucco in the gypsum slurry may be about 0.1 or more, such as about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more. The weight ratio of the water to the stucco in the gypsum slurry may be about 4 or less, such as about 3.5 or less, such as about 3 or less, such as about 2.5 or less, such as about 2 or less, such as about 1.7 or less, such as about 1.5 or less, such as about 1.4 or less, such as about 1.3 or less, such as about 1.2 or less, such as about 1.1 or less, such as about 1 or less, such as about 0.9 or less, such as about 0.85 or less, such as about 0.8 or less, such as about 0.75 or less, such as about 0.7 or less, such as about 0.65 or less, such as about 0.6 or less, such as about 0.55 or less, such as about 0.5 or less, such as about 0.45 or less, such as about 0.4 or less, such as about 0.35 or less, such as about 0.3 or less, such as about 0.25 or less, such as about 0.2 or less.

In one aspect, the reclaim composition may decrease the energy utilized in forming a gypsum panel. For instance, as previously disclosed, a gypsum panel formed in accordance with the present disclosure may utilize less water than a traditional gypsum panel. In this respect, the energy utilized to heat or dry the gypsum panel in a heating or drying device may be decreased as a result of the gypsum slurry containing less water. Further, for instance, the energy utilized in calcining fresh rock to stucco may be decreased as less stucco may be utilized in the formation of the gypsum panel disclosed herein.

In one aspect, the inclusion of the reclaim composition, including any components thereof, in the gypsum slurry may be particularly advantageous in reducing the weight of a gypsum panel. For instance, the inclusion of the reclaimed gypsum and/or reclaimed facing material in the gypsum core, including any respective gypsum core layer, may result in a lightweight gypsum panel. Further, for instance, the reclaimed gypsum and/or reclaimed facing material may be included in a heavy gypsum panel to reduce the weight of the heavy gypsum panel while also allowing the heavy gypsum panel to maintain its advantageous properties.

In one aspect, pre-formed gypsum crystals may reduce the setting time of the gypsum slurry. In this respect, the reclaim composition may include a set accelerant (e.g., reclaimed gypsum) comprising pre-formed gypsum crystals. As previously disclosed, the reclaim composition may comprise reclaimed gypsum. The reclaimed gypsum may comprise pre-formed gypsum crystals, which may be referred to as pre-formed calcium sulfate dihydrate crystals. The pre-formed gypsum crystals are pre-formed in the respect that the pre-formed gypsum crystals are formed before being incorporated into the reclaim composition.

The calcium ions and sulfate ions originating from the stucco may bond to the pre-formed gypsum crystals at gypsum crystal nucleation sites. Such gypsum crystal nucleation sites may be located at flat or uneven surfaces of a gypsum crystal. The respective bonds of the calcium and sulfate ions to the pre-formed gypsum crystals may increase the size of the pre-formed gypsum crystals.

In one aspect, varying sizes of the gypsum crystals in the gypsum core, including any gypsum core layer (e.g., first gypsum core layer, second gypsum core layer, third gypsum core layer), may form a unique gypsum crystalline matrix. For instance, the gypsum crystals formed from the reaction of stucco and water may be different from the gypsum crystals formed from the reaction of pre-formed gypsum crystals (e.g., pre-formed gypsum crystals of the reclaim composition) with calcium ions and sulfate ions. The varying sizes of the gypsum crystals may form a gypsum crystalline matrix that imparts enhanced acoustic and sound damping properties to the gypsum panel. In this respect, the varying sizes of the gypsum crystals may result in fluctuations or variations in the density of the gypsum core, which may enhance the acoustic and sound damping properties of the gypsum panel.

In one aspect, the gypsum core, including any gypsum core layer (e.g., first gypsum core layer, second gypsum core layer, third gypsum core layer), formed in accordance with the present disclosure may have a heterogenous density. In this respect, the varying sizes of the gypsum crystals may result in fluctuations or variations in the density of the gypsum core that may result in one or more respective gypsum core layers having a heterogeneous density.

In some aspects, the gypsum crystals formed from the reaction of stucco and water and the gypsum crystals formed from the reaction of pre-formed gypsum crystals (e.g., pre-formed gypsum crystals of the reclaim composition) with calcium ions and sulfate ions may form a gypsum crystalline matrix including crystals of various shapes. For instance, the gypsum crystals may be needle-shaped (e.g., acicular), tabular, bladed, or a combination thereof.

In one aspect, the gypsum slurry may include one or more binders. The one or more binders may be included in the reclaim composition. The one or more binders may include a starch, a polymer, or a combination thereof. The one or more binders may enhance the strength and/or nail pull resistance of the gypsum panel. In one aspect, the one or more binders may form a secondary or tertiary binding matrix in the gypsum core, including any of the respective gypsum core layers. When two or more binders are utilized, the binders included in the binding matrix may be selectively chosen such that they have synergistic interactions with each other and/or with the other components of the gypsum panel. The one or more binders may be added at, before, and/or after any step in the process of forming the gypsum panel of the present disclosure.

Generally, the starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. Further, for instance, the starch may be a pregelatinized starch.

In general, the polymer may be a thermoplastic polymer. However, in one embodiment, the polymer may be a thermoset polymer. The polymer may also be one that expands, such as like a foam, when exposed to heat and/or a flame. The polymer may include an acrylic polymer, a fluoropolymer, an epoxy, a urethane, a cyanurate, a rubber, an acetate polymer, or a mixture thereof. In one embodiment, the polymer may include an acrylic polymer (e.g., a vinyl toluene acrylic polymer, a styrene acrylic polymer, a silicone acrylic polymer, or a mixture thereof). In another embodiment, the polymer may include a fluoropolymer (e.g., polytetrafluoroethylene). In a further embodiment, the polymer may include an epoxy. In another further embodiment, the polymer may include a urethane polymer (e.g., polyurethane). In one embodiment, the polymer may include a cyanurate (e.g., polyisocyanurate). In a further embodiment, the polymer may include a rubber (e.g., chlorinated rubber). In another embodiment, the polymer may include an acetate polymer (e.g., polyvinyl acetate). In yet another embodiment, the polymer may include a styrene butadiene polymer.

In one embodiment, the polymer may be a viscoelastic polymer. For instance, the aforementioned acrylic polymer may be a viscoelastic polymer. In particular, the acrylic polymer may be an acrylic copolymer. In this regard, the polymer may be presented as a viscoelastic material having a broad glass transition temperature, in particular below room temperature. Such viscoelastic material may also include other additives as generally employed in the art and thus is not limited by the present invention. In general, such viscoelastic materials may allow for sound to be absorbed by the material thereby reducing the sound's amplitude and resulting energy of the sound.

In another embodiment, the one or more binders may include calcium sulfoaluminate (i.e., CSA Cement).

The one or more binders may be present in a gypsum panel, including any component (e.g., gypsum core, gypsum slurry, reclaim composition) thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The one or more binders may be present in a gypsum panel, including any component (e.g., gypsum core, gypsum slurry, reclaim composition) thereof, in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

In one aspect, one or more components of a reclaim gypsum panel included in the reclaim composition may include one or more antimicrobial additives. In this respect, the reclaim composition may include one or more antimicrobial additives. The one or more antimicrobial additives may be added at any step in the process of forming the gypsum panel of the present disclosure.

In one aspect, the one or more antimicrobial additives may be applied to and/or incorporated in reclaim gypsum panels as a spray or more generally any method known in the art. In this respect, the one or more antimicrobial additives may be applied to a gypsum panel after the gypsum panel has been identified as a reclaim gypsum panel (i.e., waste) and transferred into reclaim gypsum panel storage. The reclaim gypsum panel may be removed from reclaim gypsum panel storage and one or more components of the reclaim gypsum panel may be included in the reclaim composition of the present disclosure. In general, the application or inclusion of the one or more antimicrobial additives in a gypsum panel may increase the longevity of the gypsum panel.

In one aspect, the one or more antimicrobial additives may include a fungicide. For instance, the one or more antimicrobial additives may include more than one fungicide. In this respect, the one or more antimicrobial additives may include at least two fungicides, such as at least three fungicides

The one or more antimicrobial additives may include various fungicides. For instance, the one or more antimicrobial additives may include an azole, a strobilurin, fludioxonil, an isothiazolinone, a pyrithione, or a combination thereof.

As indicated above, the one or more antimicrobial additives may include an azole. The azole may include any azole as generally known in the art. For instance, the azole may include thiabendazole, ketoconazole, fluconazole, itraconazole, voriconazole, posaconazole, ravuconazole, tebuconazole, fluconazole.bromuconazole, epoxiconazole, cyproconazole, flusilazole, metconazole, hexaconazole, difenoconazole, propiconazole, or a mixture thereof. In one embodiment, the fungicide may include thiabendazole, ketoconazole, fluconazole, metconazole, difenoconazole, propiconazole, or a mixture thereof. In one particular embodiment, the fungicide includes thiabendazole.

As indicated above, the one or more antimicrobial additives may include a strobilurin. The strobilurin may include any strobilurin as generally known in the art. For instance, the strobilurin may include azoxystrobin, kresoxim-methyl, picoxystrobin, fluoxastrobin, oryzastrobin, dimoxystrobin, pyraclostrobin, trifloxystrobin, or a mixture thereof. In one embodiment, the strobilurin includes azoxystrobin, azoxystrobin, trifloxystrobin, or a mixture thereof. In one particular embodiment, the strobilurin includes azoxystrobin.

As indicated above, the one or more antimicrobial additives may include fludioxonil.

As indicated above, the one or more antimicrobial additives may include an isothiazolinone. The isothiazolinone may include any isothiazolinone as generally known in the art. For instance, the isothiazolinone may include benzisothiazolinone, butylbenzisothiazolinone, octylisothiazolinone, dichlorooctylisothiazolinone, methylisothiazolinone, chloromethylisothiazolinone, or a mixture thereof. In one particular embodiment, the isothiazolinones may include a mixture of methylisothiazolinone and chloromethylisothiazolinone

As indicated above the one or more antimicrobial additives may include a pyrithione. The pyrithione may be any pyrithione as generally known in the art. For instance, the pyrithione may be a zinc pyrithione, a sodium pyrithione, a copper pyrithione, or a combination thereof. In one embodiment, the pyrithione may include at least a zinc pyrithione. In another embodiment, the pyrithione may include at least a sodium pyrithione. In a further embodiment, the pyrithione may include a zinc pyrithione and a sodium pyrithione.

In one aspect, the one or more antimicrobial additives may comprise an antimicrobial additive in the form of an aqueous dispersion. For instance, an aqueous dispersion of thiabendazole, azoxystrobin, and fludioxonil (e.g., SPORGARD® WB) may be included in the one or more antimicrobial additives incorporated into the gypsum panel disclosed herein.

In another aspect, the one or more antimicrobial additives may comprise diiodomethyl-p-tolyl sulfone (e.g., FUNGIBLOCK®).

In yet another aspect, the one or more antimicrobial additives may include boric acid, sodium omadine, smectite, pyrite, or a combination thereof.

The one or more antimicrobial additives may be present in a gypsum panel, including any component (e.g., gypsum core, gypsum slurry, reclaim composition) thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The one or more antimicrobial additives may be present in a gypsum panel, including any component (e.g., gypsum core, gypsum slurry, reclaim composition) thereof, in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

In some aspects, the inclusion of one or more components of a reclaim gypsum panel (e.g., reclaimed gypsum and/or reclaimed facing material) as disclosed herein may be effective in improving the acoustical performance of a gypsum panel thereby minimizing the transmission of noise through a wall containing such gypsum panels. For instance, the sound transmission loss for a wall assembly including the gypsum panel as disclosed herein and as conducted in accordance with ASTM E90 may result in an STC rating of 20 or more, such as 25 or more, such as 30 or more, such as 35 or more, such as 40 or more, such as 45 or more, such as 50 or more, such as 55 or more, such as 60 or more. The STC rating may be less than 70, such as 65 or less, such as 60 or less, such as 55 or less, such as 50 or less, such as 45 or less, such as 40 or less. Such comparison may be determined based on a frequency curve as identified in ASTM E90.

In addition, at a frequency of 1000 Hz, the sound transmission loss of a gypsum panel formed in accordance with the present disclosure may be 55 dB or more, such as 56 dB or more, such as 57 dB or more, such as 58 dB or more, such as 60 dB or more. At a frequency of 2000 Hz, the sound transmission loss of a gypsum panel formed in accordance with the present disclosure may be more than 50 dB, such as 51 dB or more, such as 52 dB or more, such as 53 dB or more, such as 55 dB or more, such as 57 dB or more. At a frequency of 4000 Hz, the sound transmission loss of a gypsum panel formed in accordance with the present disclosure may be more than 52 dB, such as 53 dB or more, such as 55 dB or more, such as 57 dB or more, such as 59 dB or more, such as 60 dB or more.

Additionally, the noise reduction coefficient (“NRC”) of a gypsum panel incorporating one or more components of a reclaim gypsum panel (e.g., reclaimed gypsum and/or reclaimed facing material) as disclosed herein may be enhanced. The noise reduction coefficient (“NRC”) is generally a measure of the sound absorption property of a gypsum panel. Generally, an NRC value may range from 0 to 1.00. As an example, an NRC value of 0.70 means that approximately 70% of the sound is absorbed by a panel, while approximately 30% is reflected back into the environment. In this regard, gypsum panels made according to the present invention may have higher NRC values than other types of gypsum panels and in certain instances even higher NRC values than certain mineral fiber panels, indicating improved sound absorbance and acoustical properties. For instance, the NRC value of the gypsum panel disclosed herein may be 0.10 or more, such as 0.15 or more, such as 0.21 or more, such as 0.23 or more, such as 0.25 or more, such as 0.27 or more, such as 0.29 or more, such as 0.30 or more, such as 0.31 or more, such as 0.32 or more, such as 0.33 or more, such as 0.34 or more, such as 0.35 or more, such as 0.36 or more, such as 0.37 or more, such as 0.38 or more, such as 0.39 or more, such as 0.40 or more, such as 0.41 or more, such as 0.42 or more, such as 0.43 or more, such as 0.44 or more, such as 0.45 or more, such as 0.46 or more, such as 0.47 or more, such as 0.48 or more, such as 0.49 or more, such as 0.50 or more. The NRC value of the gypsum panel may be 1.00 or less, such as 0.90 or less, such as 0.80 or less, such as 0.70 or less, such as 0.60 or less, such as 0.55 or less, such as 0.53 or less, such as 0.50 or less, such as 0.48 or less, such as 0.46 or less, such as 0.45 or less, such as 0.43 or less, 0.41 or less, such as 0.40 or less. In one embodiment, the aforementioned NRC values are based on ASTM C423, herein incorporated by reference in its entirety. In another embodiment, the aforementioned NRC values are based on ASTM E1050, herein incorporated by reference in its entirety. For example, such latter test may be employed for small-scale testing.

The reclaimed gypsum may be present in a gypsum panel, including any component (e.g., gypsum core, gypsum slurry, reclaim composition) thereof, in an amount of about 99.9 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less. The reclaimed gypsum may be present in a gypsum panel, including any component (e.g., gypsum core, gypsum slurry, reclaim composition) thereof, in an amount greater than about 5 wt. %, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 95 wt. % or more, such as about 99 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition.

The reclaimed facing material may be present in a gypsum panel, including any component (e.g., gypsum core, gypsum slurry, reclaim composition) thereof, in an amount less than about 40 wt. %, such as about 30 wt. % or less, such as about 20 wt. % or less, such as about 15 wt. % or less, such as about 12 wt. % or less, such as about 10 wt. % or less, such as about 8 wt. % or less, such as about 5 wt. % or less, such as about 2 wt. % or less. The reclaimed facing material may be present in a gypsum panel, including any component (e.g., gypsum core, gypsum slurry, reclaim composition) thereof, in an amount greater than about 0.1 wt. %, such as about 0.5 wt. % or more, such as about 1 wt. % or more, such as about 2 wt. % or more, such as about 5 wt. % or more, such as about 8 wt. % or more, such as about 10 wt. % or more, such as about 15 wt. % or more, such as about 20 wt. % or more, such as about 30 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

The reclaim composition may be present in a gypsum panel, including any component (e.g., gypsum core, gypsum slurry) thereof, in an amount less than about 95 wt. %, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. or less, such as about 30 wt. % or less, such as about 25 wt. % or less, such as about 20 wt. % or less, such as about 15 wt. % or less, such as about 10 wt. % or less, such as about 5 wt. % or less. The reclaim composition may be present in a gypsum panel, including any component (e.g., gypsum core, gypsum slurry) thereof, in an amount greater than about 1 wt. %, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In one aspect, reclaim gypsum panels, including any components thereof, may first be ground to a selectively chosen particle size and then included in the reclaim composition. The reclaim gypsum panels may be ground by dry grinding, which may be referred to as dry milling, or wet grinding, which may be referred to as wet milling.

In one aspect, the reclaimed gypsum and/or reclaimed facing material may be fine particles, coarse particles, or a combination thereof. For instance, the reclaimed gypsum and/or the reclaimed facing material may have an average particle size of 6000 microns or less, such as 5000 microns or less, such as 4500 microns or less, such as 4000 microns or less, such as 3500 microns or less, such as 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The reclaimed gypsum and/or reclaimed facing material may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more, such as 3000 microns or more, such as 3500 microns or more, such as 4000 microns or more, such as 4500 microns or more, such as 5000 microns or more. Furthermore, in one aspect, the aforementioned values may refer to a median particle size of the reclaimed gypsum and/or reclaimed facing material.

In one aspect, the reclaimed gypsum and/or reclaimed facing material may have a selectively chosen particle size distribution. The particle size distribution of the reclaimed gypsum and/or reclaimed facing material may be monomodal, bi-modal, or multi-modal. In one aspect, a U.S. standard mesh size of 16 to 400, including all U.S. standard mesh sizes therebetween, may retain from about 0 wt. % to about 100 wt. % of reclaimed gypsum particles and/or reclaimed facing material particles, including all increments of 0.01 wt. % therebetween.

In general, the composition of the gypsum core is not necessarily limited and may include any additives as known in the art. For instance, the additives may include dispersants, foam or foaming agents including aqueous foam (e.g., sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g., cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. The paper facing material may have a basis weight of from about 15 lbs/MSF to about 100 lbs/MSF, such as about 15 lbs/MSF or more, such as about 30 lbs/MSF or more, such as about 35 lbs/MSF or more, such as about 40 lbs/MSF or more, such as about 45 lbs/MSF or more, such as about 50 lbs/MSF or more. The paper facing material may have a basis weight of less than about 100 lbs/MSF, such as about 60 lbs/MSF or less, such as about 55 lbs/MSF or less, such as about 50 lbs/MSF or less, such as about 45 lbs/MSF or less, such as about 40 lbs/MSF or less, such as about 35 lbs/MSF or less, such as about 30 lbs/MSF or less.

Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the composition of the gypsum slurry and gypsum core is not necessarily limited and may be any generally known in the art. Generally, in one embodiment, the gypsum core is made from a gypsum slurry including at least stucco and water. However, as indicated herein, the gypsum slurry may include a reclaim composition. In this respect, the reclaim composition may be added to the gypsum slurry at any point in the process of forming the gypsum panel Further, any optional additives as indicated herein may also be added to the gypsum slurry or the reclaim composition.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present invention.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g., sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g., cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, a foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

The manner in which the components of the gypsum slurry are combined is not necessarily limited. For instance, the gypsum slurry can be made using any method or device generally known in the art. In particular, the components of the gypsum slurry can be mixed or combined using any method or device generally known in the art. The components of the gypsum slurry may include a reclaim composition and any optional additives as indicated herein. The components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, and as previously disclosed, the calcium sulfate hemihydrate of the stucco may react with the water to hydrate the calcium sulfate hemihydrate into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Such dewatering may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

The reclaim composition may be introduced to the gypsum slurry by various methods. For instance, in one aspect, the reclaim composition may be combined with stucco (i.e., calcium sulfate hemihydrate) before the stucco is reacted with water. In this respect, the stucco and the reclaim composition may be mixed before the stucco and the reclaim composition are reacted with water. The stucco and reclaim composition may be combined by any method known in the art or disclosed herein. For instance, the stucco and the reclaim composition may be mixed or combined as is or may be ground or milled together, such as by dry milling or wet milling. In yet another aspect, the reclaim composition may be combined with the stucco after the stucco has been introduced to water. In this respect, the reclaim composition may be combined with the stucco and water after the stucco and water have partially reacted. In yet another further aspect, the stucco, water, and reclaim composition may all be combined simultaneously to form the gypsum slurry.

In one embodiment, the gypsum core may include a first gypsum core layer and a second gypsum core layer. The first gypsum core layer may be between the first facing material (i.e., front of the panel) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of foaming agent and/or foam.

In one embodiment, the gypsum core may also include a third gypsum core layer. The third gypsum core layer may be provided between the second gypsum core layer and a second facing material. In one aspect, the third gypsum core layer may be located adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers may be a particularly suitable location for the inclusion of reclaimed gypsum, reclaimed facing material, or generally any other component of a reclaim gypsum panel. For instance, when a first gypsum core layer, a second gypsum core layer, and a third gypsum core layer are present, the inclusion of reclaimed gypsum and/or reclaimed facing material may be beneficial in the second gypsum core layer. Alternatively, the inclusion of reclaimed gypsum and/or reclaimed facing material may be beneficial in the first gypsum core layer and/or third gypsum core layer. For instance, the inclusion of reclaimed gypsum and/or reclaimed facing material in the first gypsum core layer and/or third gypsum core layer may enhance the sound damping properties of the gypsum panel. In this respect, if the first gypsum core layer and/or third gypsum core layer have a different density than the other respective gypsum core layers (e.g., second gypsum core layer), the varying density of the gypsum core layers may enhance the sound damping properties of the gypsum panel.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein. Further, the first gypsum core layer, the second gypsum core layer, and/or the third gypsum core layer may contain an additive in an amount as previously indicated herein.

Regardless of the above, any of the additives disclosed herein may be present in any combination of gypsum core layers. In one aspect, one or more gypsum core layers may comprise the same additive or additives. Further, in one aspect, the one or more gypsum core layers may comprise different additives. The different additives of the one or more gypsum core layers may be chosen such that it is advantageous to have a particular additive in one gypsum core layer and a different additive in another, different gypsum core layer.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 1500 microns, such as about 90 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more. Generally, the average void size may be about 1,500 microns or less, such as about 1,300 microns or less, such as about 1,100 microns or less, such as about 1,000 microns or less, such as about 900 microns or less, such as about 800 microns or less, such as about 700 microns or less, such as about 600 microns or less, such as about 500 microns or less, such as about 400 microns or less, such as about 300 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 5 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more. The specific surface area of the gypsum core may be 5 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. The gypsum panel may have a panel weight of about 500 lbs/MSF to about 7000 lbs/MSF including all increments of 1 lb/MSF therebetween. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lbf, such as at least about 30 pounds, such as at least about 35 lbf, such as at least about 40 lbf, such as at least about 45 lbf, such as at least about 50 lbf, such as at least about 55 lbf, such as at least about 60 lbf, such as at least about 65 lbf, such as at least about 70 lbf, such as at least about 75 lbf, such as at least about 77 lbf, such as at least about 80 lbf, such as at least about 85 lbf, such as at least about 90 lbf, such as at least about 95 lbf, such as at least about 100 lbf as tested according to ASTM C1396-17. The nail pull resistance may be about 400 lbf or less, such as about 300 lbf or less, such as about 200 lbf or less, such as about 150 lbf or less, such as about 140 lbf or less, such as about 130 lbf or less, such as about 120 lbf or less, such as about 110 lbf or less, such as about 105 lbf or less, such as about 100 lbf or less, such as about 95 lbf or less, such as about 90 lbf or less, such as about 85 lbf or less, such as about 80 lbf or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lbf, such as at least about 10 lbf, such as at least about 11 lbf, such as at least about 12 lbf, such as at least about 15 lbf, such as at least about 18 lbf, such as at least about 20 lbf as tested according to ASTM C1396-17. The gypsum panel may have a core hardness of 50 lbf or less, such as about 40 lbf or less, such as about 35 lbf or less, such as about 30 lbf or less, such as about 25 lbf or less, such as about 20 lbf or less, such as about 18 lbf or less, such as about 15 lbf or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lbf, such as at least about 10 lbf, such as at least about 11 lbf, such as at least about 12 lbf, such as at least about 15 lbf, such as at least about 18 lbf, such as at least about 20 lbf, such as at least about 24 lbf, such as at least about 28 lbf, such as at least about 30 lbf, such as at least about 33 lbf as tested according to ASTM C1396-17 and ASTM C473-19. The gypsum panel may have an edge hardness of about 50 lbf or less, such as about 40 lbf or less, such as about 35 lbf or less, such as about 30 lbf or less, such as about 25 lbf or less, such as about 20 lbf or less, such as about 18 lbf or less, such as about 15 lbf or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Test Methods

Nail Pull: The nail pull is determined in accordance with ASTM C1396-17 and ASTM C473-19. For this test, the specimens are conditioned from 70° F. to 100° F., in particular 70° F., and 50%+/−2% relative humidity for at least 24 hours, positioned so they do not warp. The moisture meter reading should be between 10-20 at the time of testing. The reported value is the average of five specimens.

Humidified Bond: A humidified bond analysis is performed utilizing 12″ by 12″ specimens of the gypsum panel. The specimens are placed on edge in a humidity chamber at 90° F. and 90% humidity with faces 2+/−¼ inches apart. As reported below, the exposure was for either 2 hours or 20 hours. The specimens should have a moisture meter reading of 50+ upon completion of the humidification. Immediately, the specimens were analyzed to determine the bond. First, score lines should be scribed across the full width of the sample at 4″ from one edge on the face and 4″ in from the opposite edge on the back wherein the score lines are parallel to one another and perpendicular to the direction of machine travel. Next, firmly hold the specimen on a bench top and while face up, break the core along a score line and leave the paper intact on the side to be evaluated. Holding each portion of the specimen in separate hands and having the exposed broken core in a line of vision, exert a pulling force on one half of the specimen while holding the other half in a steady position in order to peel or tear the paper away from the core. Continue the pulling force until the paper peels away from the core to the maximum extent possible. Repeat this pulling action for the companion portion of the specimen. Then, repeat both steps for the back of the specimen. Next, determine the bond failure area where the facing material is removed from the gypsum core, with 100% indicative of no paper to gypsum core bond and 0% indicative of no paper to core failure (i.e., full paper bond to the core). A bond failure area of 25% or less is deemed as a “Pass”. The percent coverage can be determined using various optical/visual analytical techniques.

Dampening Time: The dampening time, which may be referred to as the decay time, is determined using Adobe Audition software by Adobe Systems. In particular, nominal 12″ by 12″ gypsum panel samples are suspended on a wire and impacted on one side with consistent force using a hammer with an accelerometer affixed to the opposite side from the point of impact. The dampening time is determined through the software interface by denoting the period between the initial time of impact with the sample and the time when the amplitude of the sound signal approached zero. The average of three tests is used to report the sample dampening time or decay time.

### Example 1

Gypsum panels were made from 50% virgin stucco by weight of the solids content of the gypsum core and 50% reclaimed gypsum and reclaimed paper by weight of the solids content of the gypsum core. The gypsum panels were of ⅝ inch thickness. For the panels, panel weight and nail pull resistance were determined. Varying amounts of dispersant and foam were included in each sample.

TABLE 1

| | Sample 1 | Sample 2 | Sample 3 | Sample 4 |
|---|---|---|---|---|
| Panel Weight | 1351 | 1615 | 1777 | 1909 |
| [lbs/MSF] | | | | |
| Nail Pull | 54 | 83 | 97 | 114 |
| Resistance [lb_{f}] | | | | |
| Humidified Bond | Pass | Pass | Pass | Pass |
| Weight Ratio of | 1.06 | 0.99 | 0.93 | 0.89 |
| Water to Stucco | | | | |
| Dispersant Content | 10.2 | 6.3 | 6.7 | 7.6 |
| [lbs/MSF] | | | | |
| Foam | 228 | 210 | 253 | 269 |
| [lbs/MSF] | | | | |

### Example 2

Gypsum panels were made comprising varying amounts of reclaimed gypsum and reclaimed paper, virgin stucco, water, and soap. The NRC value of the respective panels was determined. Samples 1-3 include a glass mat facing material as both facing materials of the respective gypsum panels. The gypsum core of Sample 1 was formed from 100% virgin stucco by weight of the solids content of the gypsum core. The gypsum core of Sample 2 was formed from 60% virgin stucco by weight of the solids content of the gypsum core and 40% reclaimed gypsum and reclaimed paper by weight of the solids content of the gypsum core. The gypsum core of Sample 3 was formed from 60% virgin stucco by weight of the solids content of the gypsum core and 40% reclaimed gypsum and reclaimed paper by weight of the solids content of the gypsum core. Sample 4 included a paper facing material as both facing materials of the gypsum panel. The gypsum core of Sample 4 was formed from 100% virgin stucco by weight of the solids content of the gypsum core. Table 2 and Table 3 display the data of Samples 1-4, which were tested at frequencies of 250 Hz, 500 Hz, 1000 Hz, and 2000 Hz respectively. The “NRC Average” is representative of the average NRC value of the respective samples. Regarding the soap type of Table 2 and Table 3, ‘AESBS’ refers to alkyl ether sulfate based soap and ‘AEBS’ refers to alkyl ether based soap.

TABLE 2

| | | Soap | Board | | | |
|---|---|---|---|---|---|---|
| | | Amount | Weight | NRC | NRC | NRC |
| | Soap | [lbs/ | [lbs/ | (250 | (500 | (1000 |
| Sample | Type | MSF] | MSF] | Hz) | Hz) | Hz) |
| 1 | AESBS | 0.63 | 1432 | 0.112 | 0.050 | 0.073 |
| 2 | AESBS | 0.78 | 1352 | 0.140 | 0.130 | 0.120 |
| 3 | AEBS | 0.79 | 1328 | 0.137 | 0.138 | 0.270 |
| 4 | AEBS | 0.84 | 1281 | 0.058 | 0.059 | 0.093 |

TABLE 3

| | | Soap | Board | NRC | |
|---|---|---|---|---|---|
| | Soap | Amount | Weight | (2000 | NRC |
| Sample | Type | [lbs/MSF] | [lbs/MSF] | Hz) | Average |
| 1 | AESBS | 0.63 | 1432 | 0.560 | 0.198 |
| 2 | AESBS | 0.78 | 1352 | 0.920 | 0.330 |
| 3 | AEBS | 0.79 | 1328 | 0.593 | 0.285 |
| 4 | AEBS | 0.84 | 1281 | 0.749 | 0.240 |

As observed in Table 2 and Table 3, the utilization of reclaimed gypsum and reclaimed paper in the gypsum panels substantially improved the NRC performance of the respective gypsum panels.

### Example 3

Gypsum panels were made comprising varying amounts of reclaimed gypsum and reclaimed paper, virgin stucco, water, and polymer. The gypsum core of Sample 1 was formed from 100% virgin stucco by weight of the solids content of the gypsum core. The gypsum core of Sample 2 was formed from 60% virgin stucco by weight of the solids content of the gypsum core and 40% reclaimed gypsum and reclaimed paper by weight of the solids content of the gypsum core. The gypsum core of Sample 3 was formed from 60% virgin stucco by weight of the virgin stucco, the reclaimed gypsum, and the reclaimed paper of the gypsum core, 40% reclaimed gypsum and reclaimed paper by weight of the virgin stucco, the reclaimed gypsum, and the reclaimed paper of the gypsum core, and 5% acrylic polymer by weight of the virgin stucco, the reclaimed gypsum, and the reclaimed paper of the gypsum core. The gypsum core of Sample 4 was formed from virgin stucco and 2.5% acrylic polymer by weight of the virgin stucco. The gypsum core of Sample 5 had two gypsum core layers. The first gypsum core layer, which is adjacent the first facing material, had a greater density than the second gypsum core layer. The first gypsum core layer and the second gypsum core layer were formed from 100% virgin stucco by weight of the solids content of the first gypsum core layer and the second gypsum core layer respectively. The gypsum core of Sample 6 had two gypsum core layers. The first gypsum core layer, which is adjacent the first facing material, had a greater density than the second gypsum core layer. The second gypsum core layer was formed from virgin stucco and 5% acrylic polymer by weight of the virgin stucco of the second gypsum core layer. The first gypsum core layer was formed from virgin stucco and 20% acrylic polymer by weight of the virgin stucco of the first gypsum core layer. The dampening times, measured in seconds, of the respective samples are illustrated in Table 4.

TABLE 4

| | Dampening |
|---|---|
| Sample | Time [s] |
| 1 | 0.367 |
| 2 | 0.307 |
| 3 | 0.138 |
| 4 | 0.226 |
| 5 | 0.370 |
| 6 | 0.125 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core and a first facing material and a second facing material sandwiching the gypsum core, wherein the gypsum core is formed from a gypsum slurry, the gypsum slurry comprising stucco, water, and a reclaim composition;
wherein the gypsum slurry comprises stucco in an amount from about 60 wt. % to about 95 wt. %; and
wherein the reclaim composition comprises reclaimed facing material and reclaimed gypsum, wherein the reclaimed facing material is present in the reclaim composition in an amount of about 15 wt. % or less, wherein the reclaimed facing material is present in the gypsum slurry in an amount of about 10 wt. % or less.

2. The gypsum panel of claim 1, wherein the reclaimed gypsum is present in the reclaim composition in an amount of about 70 wt. % or more.

3. The gypsum panel of claim 1, wherein the reclaimed gypsum is present in the gypsum slurry in an amount of about 5 wt. % to about 40 wt. %.

4. The gypsum panel of claim 1, wherein the weight ratio of the water to the stucco is less than about 1.

5. The gypsum panel of claim 1, wherein the weight ratio of the water to the stucco is less than about 0.8.

6. The gypsum panel of claim 1, wherein the gypsum panel weighs less than about 3000 lbs/MSF.

7. The gypsum panel of claim 1, wherein the gypsum panel weighs less than about 2500 lbs/MSF.

8. The gypsum panel of claim 1, wherein the reclaimed gypsum comprises pre-formed gypsum crystals.

9. The gypsum panel of claim 1, wherein the reclaimed gypsum has an average particle size of 1 micron to 5000 microns.

10. The gypsum panel of claim 1, wherein the reclaimed facing material has an average particle size of 1 micron to 5000 microns.

11. The gypsum panel of claim 1, wherein the reclaim composition comprises one or more antimicrobial additives.

12. The gypsum panel of claim 11, wherein the one or more antimicrobial additives comprise sodium omadine, boric acid, or a combination thereof.

13. The gypsum panel of claim 11, wherein the one or more antimicrobial additives are present in the reclaim composition in an amount of about 0.01 lbs/MSF to about 4 lbs/MSF.

14. The gypsum panel of claim 1, wherein the reclaim composition comprises one or more binders.

15. The gypsum panel of claim 14, wherein the one or more binders form a secondary or tertiary binding matrix in the gypsum core.

16. The gypsum panel of claim 14, wherein the one or more binders comprise pregelatinized starch, an acrylic polymer, a styrene butadiene polymer, CSA cement, or a combination thereof.

17. The gypsum panel of claim 14, wherein the one or more binders are present in the reclaim composition in an amount of about 1 lb/MSF to about 50 lbs/MSF.

18. The gypsum panel of claim 1, wherein the gypsum panel further comprises a dispersant in an amount of 0.01 lbs/MSF to 30 lbs/MSF.

19. The gypsum panel of claim 1, wherein the gypsum panel further comprises a foaming agent in an amount of 75 lbs/MSF to 325 lbs/MSF.

20. The gypsum panel of claim 1, wherein the gypsum core comprises a first gypsum core layer and a second gypsum core layer, the first gypsum core layer between the second gypsum core layer and the first facing material and having a density greater than the second gypsum core layer.

21. The gypsum panel of claim 20, wherein the gypsum core further comprises a third gypsum core layer between the second gypsum core layer and the second facing material and having a density greater than the second gypsum core layer.

22. The gypsum panel of claim 1, wherein the gypsum panel exhibits an STC rating of 30 or more as determined in accordance with ASTM E90.

23. The gypsum panel of claim 1, wherein the reclaimed gypsum is uncalcined.

24. The gypsum panel of claim 1, wherein the reclaimed facing material is uncalcined.

25. A method for making a gypsum panel comprising:
providing a first facing material;
depositing a gypsum slurry comprising stucco, water, and a reclaim composition, wherein the gypsum slurry comprises stucco in an amount from about 60 wt. % to about 95 wt. %, wherein the reclaim composition comprises reclaimed facing material and reclaimed gypsum, wherein the reclaimed facing material is present in the reclaim composition in an amount of about 15 wt. % or less, wherein the reclaimed facing material is present in the gypsum slurry in an amount of about 10 wt. % or less;
providing a second facing material on the gypsum slurry; and
allowing the stucco to convert to calcium sulfate dihydrate.
